(19) United States
(12) Patent Application Publication
(10) Pub. No.: US 2026/0105663 A1
(43) Pub. Date: Apr. 16, 2026

(54) IMAGE PROCESSING METHOD, APPARATUS, ELECTRONIC DEVICE AND STORAGE MEDIUM

(71) Applicant: Beijing Zitiao Network Technology Co., Ltd., Beijing (CN)

(72) Inventors: Yutao CHENG, Beijing (CN); Zhao ZHANG, Beijing (CN); Gonglei SHI, Beijing (CN); Maoke YANG, Beijing (CN)

(21) Appl. No.: 19/346,026

(22) Filed: Sep. 30, 2025

(30) Foreign Application Priority Data
Oct. 10, 2024 (CN) 202411413008.0

(51) Int. Cl. G06T 11/60; G06F 3/04845; G06F 40/40; G06T 11/20; G06V 10/40

(52) U.S. Cl. CPC G06T 11/60; G06F 40/40; G06T 11/23; G06V 10/40; G06F 3/04845; G06T 2200/24

(57) ABSTRACT

The embodiments of the present disclosure provide an image processing method, an apparatus, an electronic device and a storage medium by obtaining an image to be processed, wherein the image to be processed comprises at least two image elements; obtaining structured data corresponding to the image elements by calling an image parsing model to process the image to be processed, wherein the structured data comprises position information and appearance information of the image elements, the position information represents position features of the image elements in the image to be processed, and the appearance information represents appearance features of the image elements in the image to be processed; and generating an output image containing at least one image element in response to an editing instruction for the structured data.

### CROSS-REFERENCE TO RELATED APPLICATION(S)

This application claims priority to Chinese Application No. 202411413008.0 filed on Oct. 10, 2024, the disclosure of which is incorporated herein by reference in its entirety.

### FIELD

The embodiments of the present disclosure relate to the field of image generation technology, and in particular, to an image processing method, apparatus, electronic device, and storage medium.

### BACKGROUND

Currently, in the process of digital media production, composite images usually contain multiple layers, such as background layer, main image layer, decorative graphic layer and text layer. There are complex superposition and interdependence relationships between these layers. It is crucial to understand the layered structure of these images for image editing and material archiving of composite images.

### SUMMARY

In a first aspect, an embodiment of the present disclosure provides an image processing method, comprising:
obtaining an image to be processed, the image to be processed includes at least two image elements;
calling an image parsing model to process the image to be processed to obtain structured data corresponding to the image elements, wherein the structured data includes position information and appearance information of the image elements, the position information represents the position features of the image elements in the image to be processed, and the appearance information represents the appearance features of the image elements in the image to be processed;
in response to an editing instruction for the structured data, generating an output image containing at least one of the image elements.

In a second aspect, an embodiment of the present disclosure provides an image processing apparatus, comprising:
an obtaining module, configured to obtain an image to be processed, the image to be processed including at least two image elements;
a processing module, configured to obtain structured data corresponding to the image element by calling an image parsing model to process the image to be processed, wherein the structured data includes position information and appearance information of the image elements, the position information represents the position features of the image elements in the image to be processed, and the appearance information represents the appearance features of the image elements in the image to be processed; and
a generating module, configured to generating an output image containing at least one of the image elements in response to an editing instruction for the structured data.

In a third aspect, an embodiment of the present disclosure provides an electronic device, including: a processor and a memory, wherein:
the memory stores computer-executable instructions;
the processor executes the computer-executable instructions stored in the memory, causing the at least one processor to perform the image processing method described in the first aspect and various possible designs of the first aspect.

In a fourth aspect, an embodiment of the present disclosure provides a computer-readable storage medium, in which computer execution instructions are stored. When a processor executes the computer execution instructions, the image processing method described in the first aspect and various possible designs of the first aspect is implemented.

In a fifth aspect, an embodiment of the present disclosure provides a computer program product, including a computer program, which, when executed by a processor, implements the image processing method as described in the first aspect and various possible designs of the first aspect.

### BRIEF DESCRIPTION OF THE DRAWINGS

In order to more clearly illustrate the embodiments of the present disclosure or the technical solutions in the prior art, the drawings required for use in the embodiments or the description of the prior art will be briefly introduced below. Obviously, the drawings described below are some embodiments of the present disclosure. For ordinary technicians in this field, other drawings can be obtained based on these drawings without paying creative labor.

FIG. 1 is a diagram of an application scenario of an image processing method provided by an embodiment of the present disclosure;

FIG. 2 is a flow chart diagram 1 of an image processing method according to an embodiment of the present disclosure;

FIG. 3 is a schematic diagram of the relationship between superposition and dependency of image elements of an image to be processed provided by an embodiment of the present disclosure;

FIG. 4 is a flow chart of a specific implementation method of step S102 in the embodiment shown in FIG. 2;

FIG. 5 is a flow chart of a specific implementation method of step S1021 in the embodiment shown in FIG. 4;

FIG. 6 is a flow chart of a specific implementation method of step S1022 in the embodiment shown in FIG. 4;

FIG. 7 is a schematic diagram of the structure of an image parsing model provided by an embodiment of the present disclosure;

FIG. 8 is a schematic diagram of a mapping relationship between image elements and structured data provided by an embodiment of the present disclosure;

FIG. 9 is a flow chart of a specific implementation method of step S103 in the embodiment shown in FIG. 2;

FIG. 10 is a schematic diagram of editing structured data provided by an embodiment of the present disclosure;

FIG. 11 is a flow chart diagram 2 of an image processing method provided by an embodiment of the present disclosure;

FIG. 12 is a flow chart of a specific implementation method of step S204 in the embodiment shown in FIG. 11;

FIG. 13 is a structural block diagram of an image processing apparatus provided by an embodiment of the present disclosure;

FIG. 14 is a schematic diagram of the structure of an electronic device provided by an embodiment of the present disclosure;

FIG. 15 are schematic diagrams of the hardware structure of the electronic device provided in the embodiments of the present disclosure.

### DETAILED DESCRIPTION OF EMBODIMENTS

In the prior art, decomposing a composite image to obtain image elements in different layers is usually achieved based on the image element contours. However, the solutions in the prior art have the problem of inaccuracy in decomposing a composite image to extract image elements.

The embodiments of the present disclosure provide an image processing method, an apparatus, an electronic device, and a storage medium to overcome the problem of inaccuracy in extraction of image elements by decomposing a composite image.

In order to make the purpose, technical solution and advantages of the embodiments of the present disclosure clearer, the technical solution in the embodiments of the present disclosure will be clearly and completely described below in conjunction with the drawings in the embodiments of the present disclosure. Obviously, the described embodiments are part of the embodiments of the present disclosure, not all of the embodiments. Based on the embodiments in the present disclosure, all other embodiments obtained by ordinary technicians in this field without creative work are within the scope of protection of the present disclosure.

It should be noted that the user information (including but not limited to user device information, user personal information, etc.) and data (including but not limited to data used for analysis, stored data, displayed data, etc.) involved in this disclosure are all information and data authorized by the user or fully authorized by all parties, and the collection, use and processing of relevant data must comply with the relevant laws, regulations and standards of relevant countries and regions, and provide corresponding operation entrances for users to choose to authorize or refuse.

The application scenario of the embodiment of the present disclosure are explained below:

The image processing method provided in the embodiment of the present disclosure can be applied to an application (APP) with an image editing function, such as a camera application, a video/photo editing application, a short video application, etc. The execution subject of this embodiment can be a terminal device running the above-mentioned application with an image editing function, or a server deploying the service end corresponding to the above-mentioned application, or other electronic devices with similar functions.

Among them, in some embodiments, the terminal device or server can implement the image processing method provided in the embodiment of the present application by running various computer executable instructions or computer programs. For example, the computer executable instructions can be program-level commands, machine instructions or software instructions. The computer program can be a native program or software module in the operating system; it can be a local application, that is, a program that needs to be installed in the operating system to run, or it can be a mini program embedded in any APP, that is, a program that runs based on a browser environment. In summary, the above-mentioned computer executable instructions can be instructions in any form, and the above-mentioned computer program can be an application, module or plug-in in any form, and the specific implementation form can be configured as needed. Further, in some embodiments, the server can be an independent physical server, or a server cluster or distributed system composed of multiple physical servers, or a cloud server that provides cloud services, cloud storage, cloud communication, cloud database, cloud computing, cloud functions, network services, middleware services, domain name services, security services, content delivery networks (Content Delivery Network, CDN), and basic cloud computing services such as big data and artificial intelligence platforms, wherein the cloud service can be an interactive processing service for terminal devices to call.

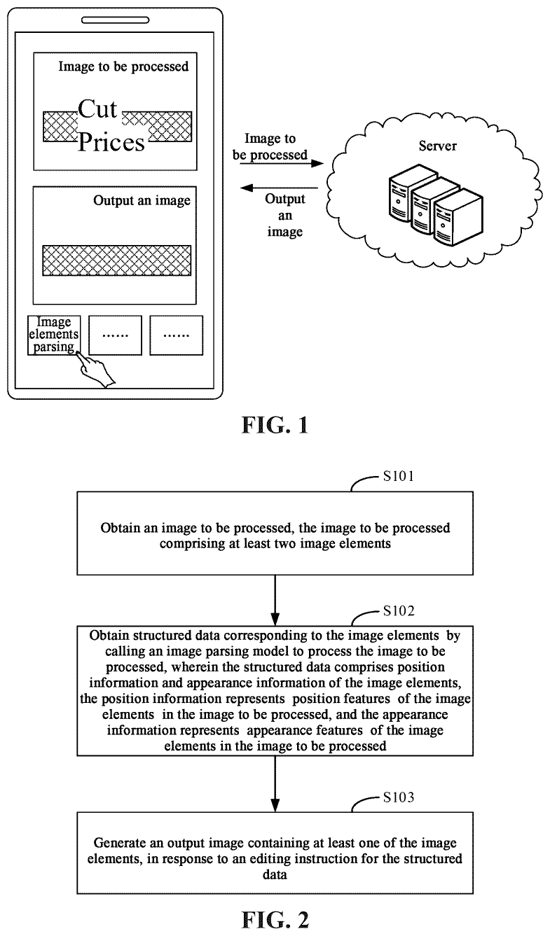

FIG. 1 is an application scenario diagram of the image processing method provided by an embodiment of the present disclosure. Referring to FIG. 1, taking the case that the server is the execution subject as an example, an application with an image editing function (hereinafter referred to as the application) is running in the terminal device. After the composite image to be processed (hereinafter referred to as the image to be processed) is loaded through the application, the terminal device sends the image to be processed to the server side for processing by triggering a response functional component, such as the “image element parsing” component shown in the figure, wherein the image to be processed includes two image elements, the first image element is an icon element “rectangle”, the interior of the “rectangle” is filled with grid lines, and the second image element is a text element “Cut Prices”. The server generates corresponding structured data based on the image to be processed through the method provided in this embodiment, and then sends it back to the terminal device. Then, the terminal device generates an output image containing at least one image element in response to the editing instruction for the structured data input by the user, thereby decomposing the composite image to be processed to extract image elements. Of course, it is understandable that in another possible implementation method, the executive subject of the method provided in this embodiment may also be the terminal device itself, that is, the above-mentioned processing process is all executed by the terminal device, and the models and algorithms used in the execution process may be all deployed locally on the terminal device, or may be partially deployed locally on the terminal device and partially deployed on external devices and called by the terminal device. The specific implementation process is similar and will not be repeated here.

In the prior art, decomposition and extraction of image elements of a composite image to be processed is usually achieved based on the image element contours. More specifically, for example, a user manually selects and captures according to the image element contours, or an application automatically identifies and captures according to the image element contours. Since there are complex superposition and interdependence relationships between the layers corresponding to the image elements, for example, the first image element blocks the second image element, the image element contours of the two have complex superposition and interdependence relationships, and then the image element features of the second image element cannot be determined when performing, for the second image element, the decomposition and extraction based on the image element contours. Therefore, the solutions in the prior art lead to the problem of inaccurate decomposition and extraction of image elements when decomposing and extracting the composite image.

The embodiment of the present disclosure provides an image processing method to solve the above-mentioned problem.

Referring to FIG. 2, FIG. 2 is a flow chart of an image processing method provided by an embodiment of the present disclosure. The method of this embodiment can be applied in a server, a terminal device or other electronic devices, and the image processing method comprises the following steps.
Step S101: an image to be processed is obtained, the image to be processed includes at least two image elements.

Referring to the schematic diagram of the application scenario shown in FIG. 1, the image processing method provided in this embodiment is introduced with the server as the execution subject. Exemplarily, a service end corresponding to an application with an image editing function is deployed in the server, and the terminal device runs the client of the application. The server and the terminal device obtain the image to be processed sent by the terminal device based on the communication between the server and the client. Further, specifically, the image to be processed contains at least two image elements, for example, the image to be processed includes four image elements, then there are complex superposition relationships and interdependence relationships between the layers corresponding to the four image elements, that is, there are complex superposition relationships and interdependence relationships between the four image elements.

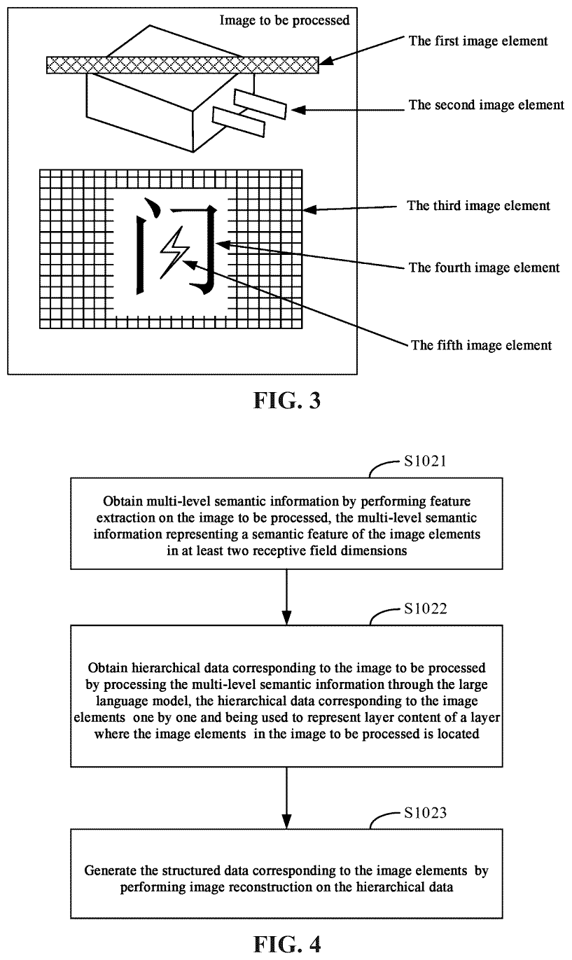

Further, for example, referring to FIG. 3, FIG. 3 is a schematic diagram of the relationship between the superposition relationship and the dependency relationship of the image elements of an image to be processed provided by an embodiment of the present disclosure, the image to be processed includes five image elements, the five image elements are a first image element, a second image element, a third image element, a fourth image element and a fifth image element, the first image element blocks the second image element, the third image element is the image background of the image to be processed, and the combined image element of the fourth image element and the fifth image element is used to indicate the image meaning of the image to be processed, and the image meaning refers to information that can be read and understood by the user, and the fourth image element alone or the fifth image element alone cannot be used to indicate the image meaning of the image to be processed. Referring to the relationship diagram shown in FIG. 3, the first image element is a banner, the second image element is a power adapter, the third image element is the image background of the image to be processed, the fourth image element is the word “door”, and the fifth image element is a lightning icon. The image to be processed is a promotional page of a power adapter, the power adapter corresponding to the second image element is the target product picture, the banner corresponding to the first image element is a decoration of the promotional page, and the combined image element of the fourth image element and the fifth image element is another decoration of the promotional page. The combined image element can be regarded as a deformation of the word “flash”, and the image meaning it indicates is that the power adapter charges quickly, that is, “flash charging”.
Step S102: the image parsing model is called to process the image to be processed to obtain structured data corresponding to the image elements, wherein the structured data includes position information and appearance information of the image elements, the position information represents the position features of the image elements in the image to be processed, and the appearance information represents the appearance features of the image elements in the image to be processed.

Exemplarily, after obtaining the image to be processed, the server calls the image parsing model to process the image to be processed, segments the image elements, and then obtains the position information and appearance information of the segmented image elements, that is, obtains the structured data corresponding to the image elements, wherein the position information represents the position features of the image elements in the image to be processed, and the appearance information represents the appearance features of the image elements in the image to be processed.

Specifically, for example, referring to the relationship diagram shown in FIG. 3, the server calls the image parsing model to process the image to be processed, obtains the geometric center coordinates of the image elements, takes the lower left corner of the image to be processed as the coordinate origin of the two-dimensional rectangular coordinate system, and uses the geometric center coordinates corresponding to the geometric centers of the image elements to indicate the position features of the image elements in the image to be processed, and then based on the geometric center coordinates of the five image elements shown in FIG. 3, the corresponding position information can be determined; further, referring to the image elements shown in FIG. 3, the server calls the image parsing model to process the image to be processed, obtains the pixel information of the image elements, and based on the pixel information of the pixel points corresponding to the image elements, the appearance features of the image elements in the image to be processed can be obtained, for example, the first image element blocks the second image element, for example, the first image element is orange and the second image element is white, then at the regional boundary of the area blocked by the first image element to the second image element, the values of the three color channels corresponding to its pixel information are different, that is, the color of the image elements and the image element contours are determined based on the pixel information, that is, the appearance features of the image elements in the image to be processed are determined. It can be understood that, for a grayscale image, its pixel information corresponds to a color channel, and its implementation method and implementation effect are similar to those of the present implementation step, and will not be repeated here.

In a possible implementation, the image parsing model includes a large language model. FIG. 4 is a flowchart of a specific implementation of step S102 in the embodiment shown in FIG. 2. As shown in FIG. 4, a specific implementation of step S102 comprises the following steps.
Step S1021: the feature extraction is performed on the image to be processed to obtain multi-level semantic information, the multi-level semantic information representing semantic features of image elements in at least two receptive field dimensions.

Exemplarily, after obtaining the image to be processed, the server calls the visual encoder to perform feature extraction on the image to be processed under at least two receptive field dimensions to obtain multi-level semantic information, and the multi-level semantic information represents the semantic features of the image elements under at least two receptive field dimensions. Specifically, for example, the multi-level semantic information includes first-level semantic information, second-level semantic information, and third-level semantic information, the first-level semantic information corresponds to the semantic features of the image elements under the first receptive field dimension, the second-level semantic information corresponds to the semantic features of the image elements under the second receptive field dimension, and the third-level semantic information corresponds to the semantic features of the image elements under the third receptive field dimension; further, referring to the relationship diagram shown in FIG. 3, the image elements under the first receptive field dimension include the third image element, the fourth image element, and the fifth image element, the image elements under the second receptive field dimension include the fourth image element and the fifth image element, and the image element under the third receptive field dimension is the fifth image element, then the first-level semantic information corresponds to the semantic features of the third image element, the fourth image element, and the fifth image element, the second-level semantic information corresponds to the semantic features of the fourth image element and the fifth image element, and the third-level semantic information corresponds to the semantic features of the fifth image element.

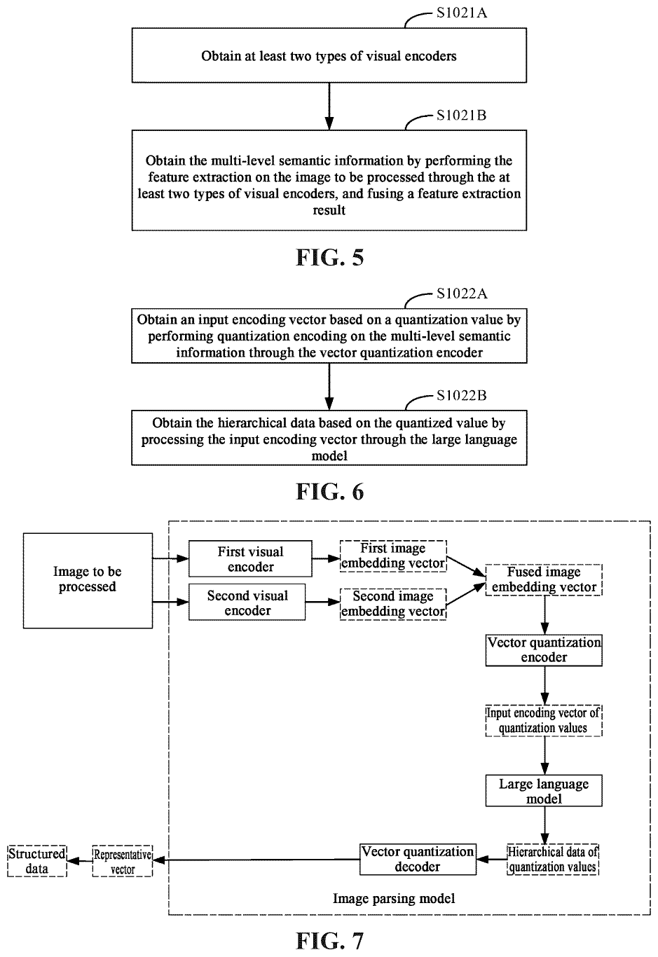

In a possible implementation, FIG. 5 is a flowchart of a specific implementation of step S1021 in the embodiment shown in FIG. 4. As shown in FIG. 5, the specific implementation of step S1021 comprises the following steps.
Step S1021A: at least two types of visual encoders are obtained.
Step S1021B: the feature extraction is performed on the image to be processed by using at least two types of visual encoders, and the feature extraction results are fused to obtain multi-level semantic information.

Exemplarily, after obtaining the image to be processed, the server obtains at least two types of visual encoders to implement feature extraction of the image to be processed through at least two types of visual encoders, obtain corresponding feature extraction results, and then fuse the feature extraction results to obtain multi-level semantic information of the image to be processed. It can be understood that when at least two types of visual encoders perform feature extraction on the image to be processed, it can be that based on the same receptive field dimension, at least two types of visual encoders perform feature extraction on the image to be processed or image elements, and then fuse the feature extraction results, or it can be that based on different receptive field dimensions, at least two types of visual encoders perform feature extraction on the image to be processed or image elements, and then fuse the feature extraction results.

Specifically, for example, after obtaining the image to be processed, the server calls two types of visual encoders, namely the first type of visual encoder and the second type of visual encoder. The first type of visual encoder is used to perform hierarchical feature processing on the image to be processed, and the second type of visual encoder is used to perform data denoising on the image to be processed. Then, for example, feature extraction is performed on the image to be processed shown in FIG. 3. Further, for example, feature extraction is performed on the fifth image element under the same receptive field dimension, and the fifth image element is a lightning icon. Then, the first type of visual encoder generates a first type of feature extraction result after hierarchical feature enhancement, and the second type of visual encoder generates a second type of feature extraction result after data denoising. Further, by fusing the first type of feature extraction result and the second type of feature extraction result, the hierarchical semantic information corresponding to the fifth image element can be obtained, that is, the hierarchical semantic information is used to describe the image features of the lightning icon under the current receptive field dimension; that is, under the same receptive field dimension, feature extraction is performed on the image to be processed shown in FIG. 3 by the first type of visual encoder and the second type of visual encoder, and the feature extraction results are fused to obtain multi-level semantic information corresponding to the image to be processed shown in FIG. 3. It can be understood that, in at least two receptive field dimensions, by performing feature extraction on the image to be processed through the first type of visual encoder and the second type of visual encoder, and fusing the feature extraction results, multi-level semantic information corresponding to the image to be processed can also be obtained.

In another possible implementation, for example, feature extraction is performed on the image to be processed shown in FIG. 3, the server calls the first type of visual encoder to perform feature extraction on the fifth image element under the second receptive field, and generates a first type of feature extraction result, and calls the second type of visual encoder to perform feature extraction on the fifth image element under the third receptive field, and generates a second type of feature extraction result. Furthermore, by fusing the first type of feature extraction result with the second type of feature extraction result, the hierarchical semantic information corresponding to the fifth image element can be obtained.

Exemplarily, the visual encoder may include any of the following: an open source visual encoder (visual model) such as a visual encoder based on Sigmoid loss for language image pre-training and a language image pre-training visual encoder. Specifically, for example, after obtaining the image to be processed, the server performs feature processing on the image to be processed based on the visual encoder A, segments the image to be processed into a series of non-overlapping image blocks, and projects them into a low-dimensional linear embedding space to generate a series of block embeddings, and then captures the long-distance dependencies in the image through the self-attention mechanism to generate image features of the image to be processed, and then determines the correspondence between the image features of the image to be processed and the text description, and based on the correspondence of the text description, generates a first image embedding vector, that is, a first feature extraction result; performs feature processing on the image to be processed based on the visual encoder B, that is, extracts rich feature representations from the image to be processed, and generates a second image embedding vector corresponding to the text description by capturing the key details and global structure in the image, that is, generates a second feature extraction result; and then fuses the first feature extraction result and the second feature extraction result to obtain multi-level semantic information.
Step S1022: hierarchical data corresponding to the image to be processed is obtained by processing multi-level semantic information through a large language model. The hierarchical data corresponds to image elements one by one and is used to represent the layer content of the layer where the image elements in the image to be processed are located.
Step S1023: image reconstruction is performed on the layered data to generate structured data corresponding to the image elements.

Exemplarily, after generating the multi-level semantic information, the server calls the large language model to process the multi-level semantic information, and the hierarchical data corresponding to the image to be processed can be obtained, wherein the hierarchical data corresponds to each image element in the image to be processed one by one, and the hierarchical data is used to represent the layer content of the layer where the image element in the image to be processed is located. Specifically, for example, referring to the relationship diagram shown in FIG. 3, taking the fourth image element in the image to be processed as an example, the multi-level semantic information includes the fourth level semantic information, and the fourth level semantic information corresponds to the semantic feature of the fourth image element, that is, the fourth level semantic information describes the fourth semantic feature of the word “door” corresponding to the fourth image element, and the large language model determines the fourth level semantic information from the multi-level semantic information, and then the large language model generates the fourth level data corresponding to the fourth image element based on the fourth level semantic information, for example, the fourth semantic feature includes the color, height, width of the word “door”, and position information of the pixel it occupies in the image to be processed, and then the fourth level data generated based on the fourth level semantic information corresponding to the fourth semantic feature describes the information included in the above fourth semantic feature, that is, corresponds to the layer content of the layer where the fourth image element is located.

Furthermore, the server generates structured data corresponding to the image element based on the hierarchical data to achieve image reconstruction. Specifically, for example, the hierarchical data corresponds to the layer content of the layer where the image elements are located in the image to be processed, and then the server generates structured data corresponding to the image element by parsing the hierarchical data and matching the corresponding structured data master. For example, in the relationship diagram shown in FIG. 3, the fourth image element corresponds to the word “door”, and its corresponding structured data master is mas_text, and then according to the hierarchical data and structured data master mas_text corresponding to the fourth image element, structured data data_1 is generated, and the fifth image element is a lightning icon, and its corresponding structured data master is mas_imag, and then according to the hierarchical data and structured data master mas_imag corresponding to the fifth image element, structured data data_2 is generated.

In a possible implementation, the image parsing model further includes a vector quantization encoder and a vector quantization decoder. FIG. 6 is a flowchart of a specific implementation of step S1022 in the embodiment shown in FIG. 4. As shown in FIG. 6, a specific implementation of step S1022 comprises the following steps.
Step S1022A: input encoding vectors based on the quantization values are obtained by quantizing and encoding the multi-level semantic information through a vector quantization encoder.
Step S1022B: hierarchical data based on quantization values are obtained by processing the input encoding vectors through the large language model.

Exemplarily, a vector quantization encoder is used to quantize and encode analog quantities to generate input encoding vectors based on quantization values; specifically, for example, for a color image to be processed, the semantic features of the image elements corresponding to the multi-level semantic information are the color vectors of the image to be processed, and the server calls the vector quantization encoder to quantize and map the color vectors of each block of the image to be processed to the closest representative vectors based on a pre-trained codebook (the codebook includes a finite number of representative vectors), and each representative vector has a corresponding code sub-index; then, the representative vector obtained by the quantization mapping is encoded based on the code sub-index, and input encoding vectors based on the quantization value are obtained. It can be understood that in another possible implementation, the semantic features of the image elements corresponding to the multi-level semantic information are the image embedding vectors of the image to be processed, and the quantization mappings and encoding processes of the image embedding vectors by the vector quantization encoder are similar to the above-mentioned implementation and implementation effect, which will not be repeated here.

Furthermore, the server calls the large language model to process the input encoding vectors, and can generate hierarchical data based on the quantization values. Specifically, for example, referring to the relationship diagram shown in FIG. 3, taking the fourth image element in the image to be processed as an example, the multi-level semantic information includes the fourth level semantic information, the vector quantization encoder quantizes and encodes the fourth level semantic information to obtain the fourth input encoding vectors based on the quantization values, the large language model determines the fourth input encoding vector from the input encoding vectors, and then based on the fourth input encoding vector, the large language model generates the corresponding hierarchical data based on the quantization value.

In the steps of this embodiment, multi-level semantic information is quantized and encoded through a vector quantization encoder, thereby achieving compression of the data volume of the image to be processed, that is, reducing the data processing volume of the large language model, and improving the data processing efficiency of the large language model and the accuracy of the output data.

Correspondingly, when the image parsing model further includes a vector quantization encoder and a vector quantization decoder, the specific implementation of step S1023 comprises: performing quantization decoding on the hierarchical data through the vector quantization decoder to generate structured data corresponding to the image elements.

Exemplarily, after the large language model generates hierarchical data based on quantization values, the server calls a vector quantization decoder to perform quantization decoding on the hierarchical data based on the quantization values to generate corresponding representative vectors. Then, based on the representative vectors, the corresponding structured data masters are matched to generate structured data corresponding to the image elements.

FIG. 7 is a schematic diagram of the structure of an image parsing model provided by an embodiment of the present disclosure, and the process of generating structured data is introduced below in conjunction with FIG. 7. Exemplarily, the image parsing model includes a first visual encoder, a second visual encoder, a vector quantization encoder, a large language model, and a vector quantization decoder, and the image parsing model is deployed in a server; after the server receives the image to be processed sent by the terminal device, the server calls the image parsing model to perform parsing processing on the image to be processed; specifically, the first visual encoder performs feature processing on the image to be processed to generate a first image embedding vector, and the second visual encoder performs feature processing on the image to be processed to generate a second image embedding vector, and then fuses the first feature extraction result and the second feature extraction result to obtain a fused image embedding vectors corresponding to multi-level semantic information; then, the vector quantization encoder performs quantization parsing encoding on the fused image embedding vectors to generate input encoding vectors of quantization values; then, the large language model generates corresponding hierarchical data based on the input encoding vectors; then, the vector quantization decoder performs quantization decoding on the hierarchical data based on the quantization values to generate a corresponding representative vectors, and matches the corresponding structured data masters, so as to generate structured data corresponding to the image element.

In the steps of this embodiment, the image parsing model parses the two-dimensional unstructured image information into structured data by segmenting each image element. At the same time, based on the superposition relationship and dependency relationship of the image elements, the structured data generated by the image parsing model can fill in the occluded parts of the image elements. Referring to the occluded icon element “rectangle” in the image to be processed in the application scenario schematic diagram shown in FIG. 1, the occluded rectangular edges can be filled in based on the structured data.
Step S103: in response to an editing instruction for structured data, an output image containing at least one image element is generated.

Exemplarily, after obtaining the structured data corresponding to the image element, the server can change the structured data, that is, edit and change the image elements, in response to the editing instructions for the structured data, and then the server loads the structured data modified based on the editing instructions by calling the renderer to generate an output image containing at least one image element. Specifically, for example, the structured data corresponding to the image elements provides data items that can be changed. For example, referring to the image elements shown in FIG. 3, the first image element is orange, and the data items that can be changed include color channel data. Then, in response to the editing instructions for changing the color, changing the color of the first image element can be finished, and the first image element after the color change can be generated.

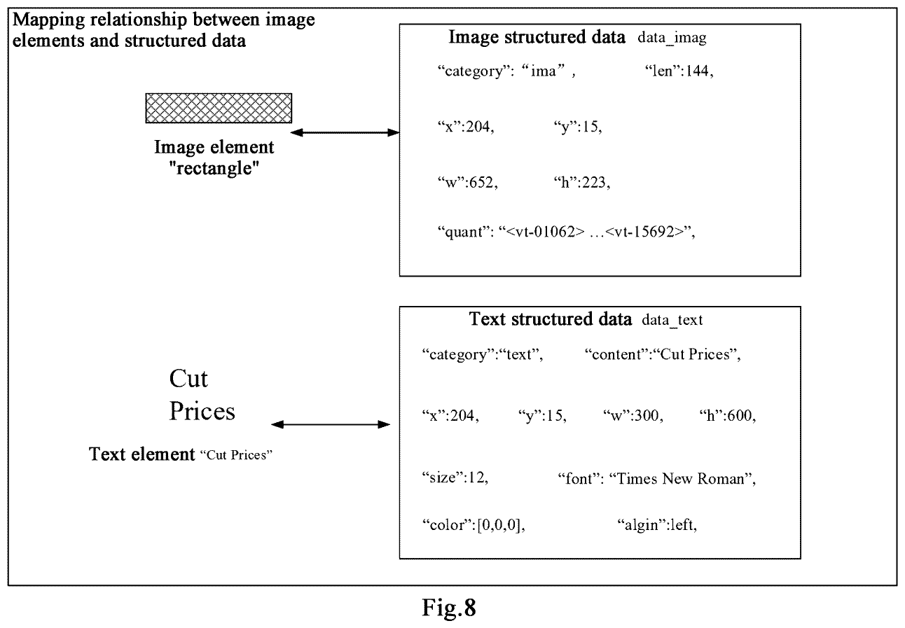

Furthermore, image elements include icon elements and text elements. Accordingly, structured data include text structured data and image structured data. Image structured data is used to characterize the appearance features of icon elements; text structured data is used to characterize the text content and font attributes of text elements. FIG. 8 is a schematic diagram of a mapping relationship between an image element and structured data provided by an embodiment of the present disclosure. As shown in FIG. 8, referring to the image to be processed in the application scenario schematic diagram shown in FIG. 1, the image to be processed includes two image elements, the first image element is an icon element “rectangle”, the interior of the “rectangle” is filled with grid lines, and the second image element is a text element “Cut Prices”; further, with respect to the mapping relationship between the icon element and the image structured data, the image structured data data_imag includes “category, object length, position, size, and appearance features”. Taking the icon element “rectangle” as an example, as shown in FIG. 8, the “category” in the image structured data data_imag is “category”: “ima”, the “object length” is “len”: 144, the “position” is “x”: 204, “y”: 15, the “size” is “w”: 652, “h”: 223, and the “appearance features” is “quant”: “<vt-01062> . . . <vt-15692>”, wherein, in a possible implementation, “quant”: “<vt-01062> . . . <vt-15692>” is the representative vector generated by the vector quantization decoder based on the hierarchical data of the quantization values in the steps of the above embodiment; with respect to the mapping relationship between text elements and text structured data, the text structured data data_text includes text content and font attributes, specifically, including “category, text content, position, size, font size, font, font color, and arrangement”. Taking the text element “Cut Prices” as an example, as shown in FIG. 8, the “category” in the text structured data data_text is “category”: “text”, “text content” is “content”: “Cut Prices”, “position” is “x”: 204, “y”: 15, “size” is “w”: 300, “h”: 600, “font size” is “size”: 12, “font” is “font”: “Times New Roman”, “font color” is “color”: [0,0,0], and “arrangement” is “algin”: left.

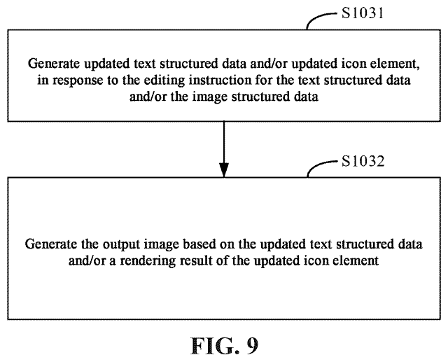

In a possible implementation, FIG. 9 is a flowchart of a specific implementation of step S103 in the embodiment shown in FIG. 2. As shown in FIG. 9, the specific implementation of step S103 comprises the following steps.
Step S1031: updated text structured data and/or updated icon elements are generated in response to editing instructions for text structured data and/or image structured data.
Step S1032: an output image is generated based on the updated text structured data and/or the rendering results of the updated icon elements.

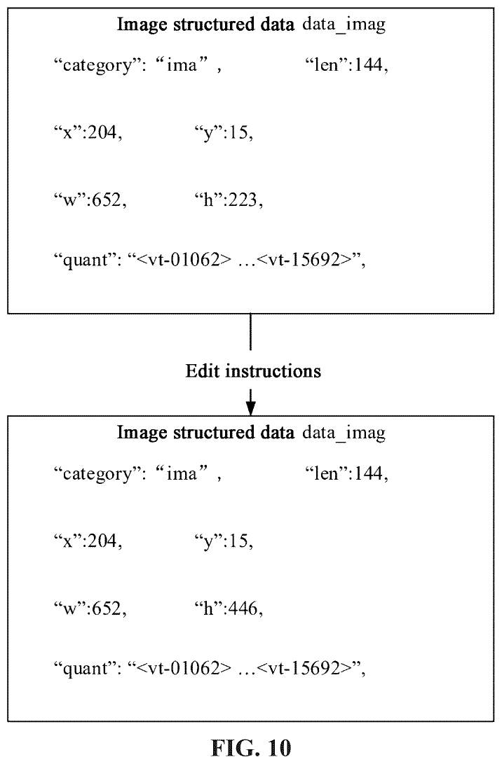

Exemplarily, FIG. 10 is a schematic diagram of editing structured data provided by an embodiment of the present disclosure. As shown in FIG. 10, the server updates the text structured data in response to an editing instruction for text structured data. For example, if the editing instruction is “change the font size of the text content to 15”, then reference is made to the text structured data data_text shown in FIG. 8. Before the update, “size” corresponds to 12. Based on the editing instruction, in the updated text structured data generated, “size” corresponds to 15; the server updates the image structured data in response to an editing instruction for image structured data. For example, if the editing instruction is “double the height of the rectangle”, then reference is made to the image structured data data_imag shown in FIG. 8. Before the update, “h” corresponds to 223. Based on the editing instruction, in the updated image structured data generated, “h” corresponds to 446, that is, the height of the generated updated icon element “rectangle” is doubled. Further, the server generates an output image by calling a renderer to load the updated text structured data and/or the updated icon element for rendering.

In the steps of this embodiment, based on the editable structured data, the server responds to the editing instructions for the image elements, and by changing the structured data, and then generates updated text structured data and/or updated icon elements, thereby realizing the editing and updating of the image elements in the processed image.

In this embodiment, by obtaining an image to be processed, the image to be processed includes at least two image elements; calling an image parsing model to process the image to be processed, and obtaining structured data corresponding to the image elements, wherein the structured data includes position information and appearance information of the image elements, the position information represents the position features of the image elements in the image to be processed, and the appearance information represents the appearance features of the image element in the image to be processed; in response to an editing instructions for the structured data, generating an output image including at least one image element. On the basis of segmenting each image element in the image to be processed by the image parsing model, the position features and appearance features of each image element in the image to be processed are extracted by the image parsing model to obtain the corresponding editable position information and appearance information, and the editable structured data corresponding to the image element can be generated. Further, based on the editing instruction for the structured data, the structured data is updated and edited, and an output image containing at least one image element can be generated; the two-dimensional unstructured image information of the image to be processed is parsed into structured data, and the problem of inaccurate decomposition of image elements caused by decomposing composite image to extract image elements based on the image element contour is solved.

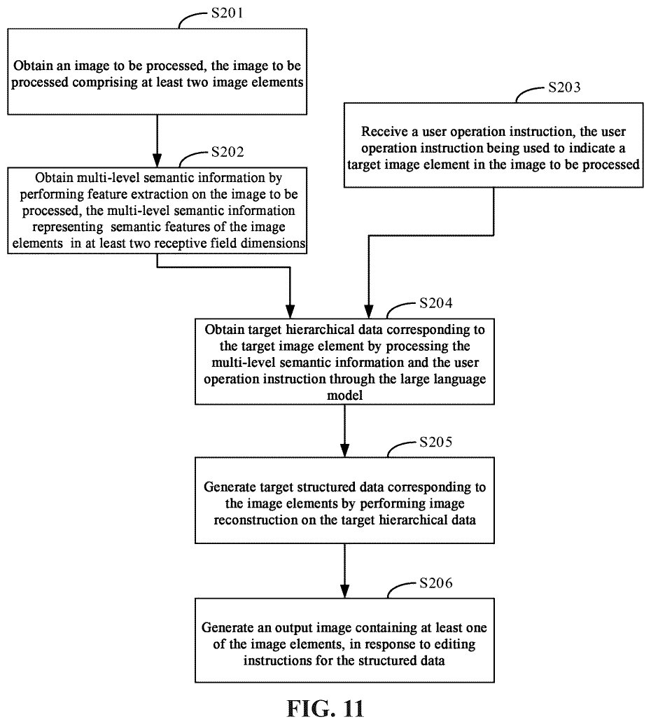

Referring to FIG. 11, FIG. 11 is a flow chart diagram 2 of an image processing method provided by an embodiment of the present disclosure. Based on the embodiment shown in FIG. 2, this embodiment further refines step S102, and the image processing method comprises the following steps.
Step S201: an image to be processed is obtained, the image to be processed includes at least two image elements.
Step S202: feature extraction is performed on the image to be processed to obtain features of image elements in at least two receptive field dimensions.
Step S203: user operation instructions are received, the user operation instruction is used to indicate a target image element in the image to be processed.
Step S204: multi-level semantic information and user operation instructions are processed through a large language model to obtain target hierarchical data corresponding to the target image elements.

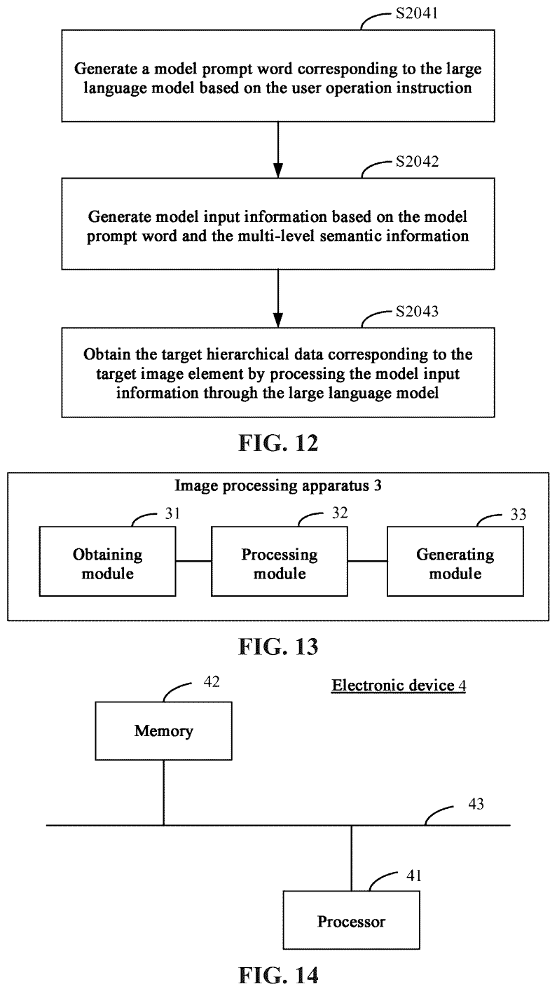

Exemplarily, FIG. 12 is a flowchart of a specific implementation of step S204 in the embodiment shown in FIG. 11. As shown in FIG. 12, the specific implementation of step S204 comprises the following steps.
Step S2041: model prompt words corresponding to the large language model are generated based on the user operation instructions.
Step S2042, model input information is generated based on the model prompt words and multi-level semantic information.
Step S2043, the model input information is processed through the large language model to obtain target hierarchical data corresponding to the target image elements.

Exemplarily, the terminal device generates user operation instructions based on the interactive operation performed by the user, and the user operation instructions are used to indicate the target image elements selected by the user in the image to be processed, and then the server obtains the user operation instructions sent by the terminal device based on the communication between the server and the client. Specifically, for example, the terminal device includes a touch display screen, and the user touches and presses a certain area of the image to be processed, then the image elements in the area are the target image elements, and then the terminal device generates user operation instructions corresponding to the target image elements based on the user's touch operation. Furthermore, the server receives the user operation instructions sent by the terminal device, processes the user operation instructions, and generates a model prompt word that can be recognized by the large language model. Specifically, for example, taking the lower left corner of the image to be processed as the coordinate origin of the two-dimensional rectangular coordinate system, the position information of the pressing area of the image to be processed where the user touches and presses can be determined based on the user operation instruction, for example, the position coordinate set of the pressing area, that is, the position information corresponding to the target image elements, and then the server generates a model prompt words based on the position information, for example, “take the lower left corner of this image as the coordinate origin of the two-dimensional rectangular coordinate system, obtain the image elements in this image within the coordinate range determined by the position coordinate set {(x1,y1) [symbol] (x2,y2) [symbol] . . . [symbol] (xn,yn)}”.

Furthermore, the multi-level semantic information includes target multi-level semantic information corresponding to the target image elements, that is, the target multi-level semantic information is used to characterize the semantic features of the target image elements under at least two receptive field dimensions, and then the target multi-level semantic information is determined from the multi-level semantic information based on the model prompt words, thereby generating the model input information. Specifically, for example, the model prompt words are “take the lower left corner of this image as the coordinate origin of the two-dimensional rectangular coordinate system, and obtain the image elements in this image within the coordinate range determined by the position coordinate set {(x1,y1), (x2,y2), . . . , (xn,yn)}”, and then based on the position coordinate set, determine the semantic feature set related to the position coordinate set from the multi-level semantic information, and then determine the multi-level semantic information corresponding to the semantic feature set as the target multi-level semantic information; further, the target multi-level semantic information can be used as model input information for processing by the large language model to obtain target hierarchical data corresponding to the target image elements; or the target multi-level semantic information is quantized and encoded by a vector quantization encoder to generate model input information based on quantization values, and then the large language model processes the model input information based on quantization values to obtain target hierarchical data corresponding to the target image elements, and the target hierarchical data is hierarchical data based on quantization values corresponding to the target image elements.

Furthermore, in a possible implementation, the user operation instruction includes a first operation instruction or a second operation instruction, wherein the first operation instruction includes a coordinate value describing the position of the target image element; and the second operation instruction includes text describing the position of the target image element. Specifically, the first operation instruction is based on the coordinate value of the position of the target image element in the image to be processed determined by the user through the input/output (I/O) interface of the terminal device. For example, in the display interface of the terminal device, the user clicks/selects the position area of the target image element in the image to be processed with the mouse, or, in the touch-sensitive display interface of the terminal device, the user clicks/selects the position area of the target image element in the image to be processed with a limb (such as a finger), and then the terminal device generates the first operation instruction based on the user's operation; the second operation instruction is generated based on the text input by the user through the I/O interface, such as keyboard input or microphone voice input. For example, the user inputs the text “output the icon in this image” according to the image to be processed displayed by the terminal device, then the coordinate position of the icon in this image corresponds to the text of the position. If the input text is “output the icon in the upper left corner of this image”, then “upper left corner” is the text of the position, which is used to indicate the icon selected by the user.

In the present embodiment, the large language model, on the basis of obtaining multi-level semantic information, realizes personalized processing of the image to be processed based on the user operation instructions and the multi-level semantic information by responding to the user operation instructions, and generates the target hierarchical data of the target image elements corresponding to the user operation instructions in a targeted manner, thereby providing data support for subsequent image reconstruction and editing of the target image elements; at the same time, since the target hierarchical data of the target image elements can be generated in a targeted manner through the user operation instructions and the multi-level semantic information, the data processing volume of the large language model for processing the multi-level semantic information is reduced, thereby improving the data processing efficiency of the large language model.
Step S205: the target hierarchical data is reconstructed to generate target structured data corresponding to the target image elements.
Step S206: in response to an editing instruction for the target structured data, an output image containing at least one target image element is generated.

In this embodiment, the implementation of step S201, step S202, step S205, and step S206 is the same as the implementation of step S101, and the corresponding sub-steps in step S102 and step S103 in the embodiment shown in FIG. 2 of the present disclosure, and will not be repeated here.

Furthermore, before all the steps, it also includes a training process for the image parsing model. The training process of the image parsing model through sample images comprises: obtaining a sample image, and marking the sample image elements in the sample image, the sample image elements include sample icon elements and sample text elements, and further, marking the appearance features of the sample icon elements to generate corresponding sample icon element labels, marking the text content and font attributes of the sample text elements to generate corresponding sample text element labels; and then, inputting the sample image into the initial image parsing model to generate a process element label, and then adjusting the parameters of the image parsing model based on the residuals of the process element label and the sample text element label, and the residuals of the element label and the sample icon element label, until the residual value meets the preset standard, thereby obtaining the image parsing model.

Furthermore, when the sample images and the sample user operation instructions are used as two inputs of the model, the training process of the image parsing model is similar to the above training process and will not be repeated here.

Corresponding to the image processing method of the above embodiment, FIG. 13 is a block diagram of the structure of the image processing apparatus provided by the embodiment of the present disclosure. The method introduced in the above embodiment can be executed by the image processing apparatus, which can be implemented by software and/or hardware, and the apparatus can be integrated in an electronic device with certain data processing functions. Among them, the electronic device can include but is not limited to a mobile terminal with big data processing capabilities, and a fixed terminal with big data processing capabilities such as a desktop computer and a supercomputer.

For convenience of explanation, only parts related to the embodiment of the present disclosure are shown. Referring to FIG. 13, the image processing apparatus 3 comprises:
an obtaining module 31, configured to obtain an image to be processed, the image to be processed includes at least two image elements;
a processing module 32, configured to call the image parsing model to process the image to be processed, and obtain the structured data corresponding to the image elements, wherein the structured data includes the position information and appearance information of the image elements, the position information represents the position features of the image elements in the image to be processed, and the appearance information represents the appearance features of the image elements in the image to be processed; and
a generating module 33, configured to generate an output image containing at least one of the image elements in response to editing instructions for the structured data.

According to one or more embodiments of the present disclosure, the image parsing model includes a large language model. When the processing module 32 calls the image parsing model to process the image to be processed and obtains the structured data corresponding to the image elements, it is specifically configured to: perform feature extraction on the image to be processed to obtain multi-level semantic information, and the multi-level semantic information representing the semantic features of the image elements under at least two receptive field dimensions; process the multi-level semantic information through the large language model to obtain hierarchical data corresponding to the image to be processed, and the hierarchical data corresponding to the image elements one by one and being used to represent the layer content of the layer where the image elements in the image to be processed are located; perform image reconstruction on the hierarchical data to generate structured data corresponding to the image elements.

According to one or more embodiments of the present disclosure, when the processing module 32 performs feature extraction on the image to be processed to obtain multi-level semantic information, it is specifically configured to: obtain at least two types of visual encoders; perform feature extraction on the image to be processed through the at least two types of visual encoders, and fuse the feature extraction results to obtain the multi-level semantic information.

According to one or more embodiments of the present disclosure, the image parsing model also includes a vector quantization encoder and a vector quantization decoder. When the processing module 32 processes the multi-level semantic information through a large language model to obtain the hierarchical data corresponding to the image to be processed, it is specifically configured to: quantize and encode the multi-level semantic information through the vector quantization encoder to obtain an input encoding vectors based on the quantization values; process the input encoding vectors through the large language model to obtain hierarchical data based on the quantization values; when the processing module 32 reconstructs the hierarchical data to generate the structured data corresponding to the image elements, it is specifically configured to: quantize and decode the hierarchical data through the vector quantization decoder to generate the structured data corresponding to the image elements.

According to one or more embodiments of the present disclosure, the processing module 32 is also configured to: receive user operation instructions, the user operation instructions being used to indicate target image elements in the image to be processed; when the processing module 32 processes the multi-level semantic information through a large language model to obtain hierarchical data corresponding to the image to be processed, the processing module 32 is specifically configured to: process the multi-level semantic information and the user operation instructions through a large language model to obtain target hierarchical data corresponding to the target image elements.

According to one or more embodiments of the present disclosure, when the processing module 32 processes the multi-level semantic information and the user operation instructions through a large language model to obtain the target hierarchical data corresponding to the target image elements, it is specifically configured to: generate a model prompt words corresponding to the large language model based on the user operation instructions; generate model input information based on the model prompt words and the multi-level semantic information; and process the model input information through a large language model to obtain the target hierarchical data corresponding to the target image elements.

According to one or more embodiments of the present disclosure, the user operation instructions include a first operation instructions or a second operation instructions, wherein the first operation instructions include a coordinate values describing the positions of the target image elements; and the second operation instructions include text describing the positions of the target image elements.

According to one or more embodiments of the present disclosure, the image elements include icon elements and text elements, the structured data include text structured data and image structured data, the image structured data is used to characterize the appearance features of the icon elements; the text structured data is used to characterize the text content and font attributes of the text elements, and the generation module 33, when generating an output image containing at least one of the image elements in response to an editing instructions for the structured data, is specifically configured to: generate updated text structured data and/or updated icon elements in response to an editing instructions for the text structured data and/or the image structured data; and generate the output image based on the rendering results of the updated text structured data and/or the updated icon elements.

Among them, the obtaining module 31, the processing module 32 and the generation module 33 are connected in sequence. The image processing apparatus 3 provided in this embodiment can execute the technical solution of the above method embodiment, and its implementation principle and technical effect are similar, which will not be repeated in this embodiment.

FIG. 14 is a schematic diagram of the structure of an electronic device provided by an embodiment of the present disclosure. As shown in FIG. 14, the electronic device 4 comprises:
a processor 41, and a memory 42 communicatively connected to the processor 41, wherein:
the memory 42 stores computer-executable instructions; and
the processor 41 executes the computer-executable instructions stored in the memory 42 to implement the image processing method in the embodiments shown in FIG. 2 to FIG. 12.

Among them, optionally, the processor 41 and the memory 42 are connected via a bus 43.

The related descriptions can be understood by referring to the relevant descriptions and effects corresponding to the steps in the embodiments corresponding to FIG. 2 to FIG. 12, and no further details will be given here.

An embodiment of the present disclosure provides a computer-readable storage medium, in which computer-executable instructions are stored. The computer-executable instructions, when executed by a processor, are used to implement the image processing method provided in any one of the embodiments corresponding to FIG. 2 to FIG. 12 of the present disclosure.

An embodiment of the present disclosure provides a computer program product, including a computer program, which, when executed by a processor, implements the image processing method provided by any one of the embodiments corresponding to FIG. 2 to FIG. 12 of the present disclosure.

In order to implement the above embodiment, the embodiment of the present disclosure also provides an electronic device.

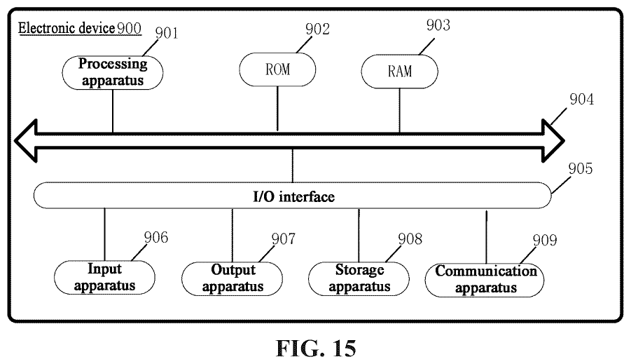

Referring to FIG. 15, FIG. 15 is a schematic diagram of the hardware structure of an electronic device provided by an embodiment of the present disclosure, which shows a schematic diagram of the structure of an electronic device 900 suitable for implementing an embodiment of the present disclosure, and the electronic device 900 may be a terminal device or a server. Among them, the terminal device may include but is not limited to mobile terminals such as mobile phones, laptop computers, digital broadcast receivers, personal digital assistants (PDAs), tablet computers (Portable Android Devices, PADs), portable multimedia players (PMPs), vehicle-mounted terminals (such as vehicle-mounted navigation terminals), etc., and fixed terminals such as digital TVs, desktop computers, etc. The electronic device shown in FIG. 15 is only an example and should not bring any limitation to the functions and scope of use of the embodiments of the present disclosure.

As shown in FIG. 15, the electronic device 900 may include a processing apparatus (such as a central processing unit, a graphics processor, etc.) 901, which may perform various appropriate actions and processes according to programs stored in a Read Only Memory (ROM) 902 or programs loaded from a storage device 908 into a Random Access Memory (RAM) 903. In the RAM 903, various programs and data required for the operation of the electronic device 900 are also stored. A processing apparatus 901, a ROM 902 and a RAM 903 are connected to each other through a bus 904. An input/output (I/O) interface 905 is also connected to the bus 904.

Typically, the following apparatus may be connected to the I/O interface 905: input apparatus 906 including, for example, a touch screen, a touchpad, a keyboard, a mouse, a camera, a microphone, an accelerometer, a gyroscope, etc.; output apparatus 907 including, for example, a liquid crystal display (LCD), a speaker, a vibrator, etc.; storage apparatus 908 including, for example, a magnetic tape, a hard disk, etc.; and communication apparatus 909. The communication apparatus 909 may allow the electronic device 900 to communicate with other devices wirelessly or by wire to exchange data. Although FIG. 15 shows an electronic device 900 having various apparatus, it should be understood that it is not required to implement or have all the apparatus shown. More or fewer apparatus may be implemented or have alternatively.

In particular, according to an embodiment of the present disclosure, the process described above with reference to the flowchart can be implemented as a computer software program. For example, an embodiment of the present disclosure includes a computer program product, which includes a computer program carried on a computer-readable medium, and the computer program contains program code for executing the method shown in the flowchart. In such an embodiment, the computer program can be downloaded and installed from a network through a communication apparatus 909, or installed from a storage apparatus 908, or installed from a ROM 902. When the computer program is executed by the processing apparatus 901, the above-mentioned functions defined in the method of the embodiment of the present disclosure are executed.

It should be noted that the computer-readable medium mentioned above in the present disclosure may be a computer-readable signal medium or a computer-readable storage medium or any combination of the above two. The computer-readable storage medium may be, for example, but not limited to, an electrical, magnetic, optical, electromagnetic, infrared, or semiconductor system, device or device, or any combination of the above. More specific examples of computer-readable storage media may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium may be any tangible medium containing or storing a program that can be used by or in combination with an instruction execution system, device or device. In the present disclosure, a computer-readable signal medium may include a data signal propagated in a baseband or as part of a carrier wave, in which a computer-readable program code is carried. Such propagated data signals may take a variety of forms, including but not limited to electromagnetic signals, optical signals, or any suitable combination of the above. Computer readable signal media may also be any computer readable medium other than computer readable storage media, which may send, propagate or transmit a program for use by or in conjunction with an instruction execution system, apparatus or device. The program code contained on the computer readable medium may be transmitted using any appropriate medium, including but not limited to: wires, optical cables, RF (radio frequency), etc., or any suitable combination of the above.

The computer-readable medium may be included in the electronic device, or may exist independently without being incorporated into the electronic device.

The computer-readable medium carries one or more programs. When the one or more programs are executed by the electronic device, the electronic device executes the method shown in the above embodiment.

Computer program code for performing the operations of the present disclosure may be written in one or more programming languages or a combination thereof, including object-oriented programming languages such as Java, Smalltalk, C++, and conventional procedural programming languages such as “C” or similar programming languages. The program code may be executed entirely on the user's computer, partially on the user's computer, as a separate software package, partially on the user's computer and partially on a remote computer, or entirely on a remote computer or server. In the case of a remote computer, the remote computer may be connected to the user's computer through any type of network, including a Local Area Network (LAN) or a Wide Area Network (WAN), or may be connected to an external computer (e.g., through the Internet using an Internet service provider).

The flow chart and block diagram in the accompanying drawings illustrate the possible architecture, function and operation of the system, method and computer program product according to various embodiments of the present disclosure. In this regard, each square box in the flow chart or block diagram can represent a module, a program segment or a part of a code, and the module, the program segment or a part of the code contains one or more executable instructions for realizing the specified logical function. It should also be noted that in some implementations as replacements, the functions marked in the square box can also occur in a sequence different from that marked in the accompanying drawings. For example, two square boxes represented in succession can actually be executed substantially in parallel, and they can sometimes be executed in the opposite order, depending on the functions involved. It should also be noted that each square box in the block diagram and/or flow chart, and the combination of the square boxes in the block diagram and/or flow chart can be implemented with a dedicated hardware-based system that performs a specified function or operation, or can be implemented with a combination of dedicated hardware and computer instructions.

The units or modules involved in the embodiments described in the present disclosure may be implemented by software or hardware, wherein the name of a unit or module does not, in some cases, constitute a limitation on the unit itself.

The functions described above herein may be performed at least in part by one or more hardware logic components. For example, without limitation, exemplary types of hardware logic components that may be used include: field programmable gate arrays (FPGAs), application specific integrated circuits (ASICs), application specific standard products (ASSPs), systems on chips (SOCs), complex programmable logic devices (CPLDs), and the like.

In the context of the present disclosure, a machine-readable medium may be a tangible medium that may contain or store a program for use by or in conjunction with an instruction execution system, device, or equipment. A machine-readable medium may be a machine-readable signal medium or a machine-readable storage medium. A machine-readable medium may include, but is not limited to, an electronic, magnetic, optical, electromagnetic, infrared, or semiconductor system, device, or device, or any suitable combination of the foregoing. A more specific example of a machine-readable storage medium may include an electrical connection based on one or more lines, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

In a first aspect, according to one or more embodiments of the present disclosure, there is provided an image processing method, comprising:

obtaining an image to be processed, wherein the image to be processed includes at least two image elements; calling an image parsing model to process the image to be processed to obtain structured data corresponding to the image elements, wherein the structured data includes position information and appearance information of the image elements, the position information represents positional features of the image elements in the image to be processed, and the appearance information represents appearance features of the image elements in the image to be processed; and generating an output image containing at least one of the image elements in response to editing instructions for the structured data.

According to one or more embodiments of the present disclosure, the image parsing model includes a large language model, and calling the image parsing model to process the image to be processed to obtain structured data corresponding to the image elements comprises: performing feature extraction on the image to be processed to obtain multi-level semantic information, and the multi-level semantic information representing the semantic features of the image elements under at least two receptive field dimensions; processing the multi-level semantic information through a large language model to obtain hierarchical data corresponding to the image to be processed, the hierarchical data corresponding to the image elements one by one and used to represent the layer content of the layer where the image elements in the image to be processed are located; and performing image reconstruction on the hierarchical data to generate structured data corresponding to the image elements.

According to one or more embodiments of the present disclosure, performing feature extraction on the image to be processed to obtain multi-level semantic information, comprises: obtaining at least two types of visual encoders; and performing feature extraction on the image to be processed by using the at least two types of visual encoders, and fusing the feature extraction results to obtain the multi-level semantic information.

According to one or more embodiments of the present disclosure, the image parsing model also includes a vector quantization encoder and a vector quantization decoder, and processing the multi-level semantic information through a large language model to obtain hierarchical data corresponding to the image to be processed comprises: quantizing and encoding the multi-level semantic information through the vector quantization encoder to obtain input encoding vectors based on quantization values; processing the input encoding vector through the large language model to obtain hierarchical data based on quantization values; and performing image reconstruction on the hierarchical data to generate structured data corresponding to the image elements, comprising: quantizing and decoding the hierarchical data through the vector quantization decoder to generate structured data corresponding to the image elements.

According to one or more embodiments of the present disclosure, the method further comprises: receiving a user operation instruction, the user operation instruction being used to indicate a target image element in the image to be processed; and processing the multi-level semantic information through a large language model to obtain hierarchical data corresponding to the image to be processed, comprising: processing the multi-level semantic information and the user operation instruction through a large language model to obtain target hierarchical data corresponding to the target image element.

According to one or more embodiments of the present disclosure, processing the multi-level semantic information and the user operation instruction by a large language model to obtain the target hierarchical data corresponding to the target image elements comprises: generating model prompt words corresponding to the large language model based on the user operation instruction; generating model input information based on the model prompt words and the multi-level semantic information; and processing the model input information by a large language model to obtain the target hierarchical data corresponding to the target image elements.

According to one or more embodiments of the present disclosure, the user operation instructions include a first operation instructions or a second operation instructions, wherein the first operation instructions include a coordinate values describing the positions of the target image elements; and the second operation instructions include text describing the positions of the target image elements.

According to one or more embodiments of the present disclosure, the image elements include icon elements and text elements, the structured data include text structured data and image structured data, the image structured data is used to characterize the appearance features of the icon elements; the text structured data is used to characterize the text content and font attributes of the text elements, and generating the output image containing at least one of the image elements in response to editing instructions for the structured data, comprising: generating updated text structured data and/or updated icon elements in response to editing instructions for the text structured data and/or the image structured data; and generating the output image based on the rendering results of the updated text structured data and/or updated icon elements.

In a second aspect, according to one or more embodiments of the present disclosure, there is provided an image processing apparatus, comprising:
an obtaining module, configured to obtain an image to be processed, the image to be processed includes at least two image elements;
a processing module, configured to obtain structured data corresponding to the image elements by calling an image parsing model to process the image to be processed, wherein the structured data includes position information and appearance information of the image elements, the position information represents the position features of the image elements in the image to be processed, and the appearance information represents the appearance features of the image elements in the image to be processed; and
a generating module, configured to generate an output image containing at least one of the image elements in response to an editing instruction for the structured data.

In a third aspect, according to one or more embodiments of the present disclosure, there is provided an electronic device, comprising: at least one processor and a memory, wherein:
the memory stores computer-executable instructions;
the at least one processor executes the computer-executable instructions stored in the memory, causing the at least one processor performs the image processing method described in the first aspect and various possible designs of the first aspect.

In a fourth aspect, according to one or more embodiments of the present disclosure, a computer-readable storage medium is provided, wherein the computer-readable storage medium stores computer execution instructions, which, when executed by a processor, implement the image processing method described in the first aspect and various possible designs of the first aspect.

In a fifth aspect, according to one or more embodiments of the present disclosure, a computer program product is provided, including a computer program, which, when executed by a processor, implements the image processing method described in the first aspect and various possible designs of the first aspect.

The above description is only a preferred embodiment of the present disclosure and an explanation of the technical principles used. Those skilled in the art should understand that the scope of disclosure involved in the present disclosure is not limited to the technical solutions formed by a specific combination of the above technical features, but should also cover other technical solutions formed by any combination of the above technical features or their equivalent features without departing from the above disclosed concept. For example, the above features are replaced with the technical features with similar functions disclosed in the present disclosure (but not limited to) by each other to form a technical solution.

In addition, although each operation is described in a specific order, this should not be understood as requiring these operations to be performed in the specific order shown or in a sequential order. Under certain circumstances, multitasking and parallel processing may be advantageous. Similarly, although some specific implementation details are included in the above discussion, these should not be interpreted as limiting the scope of the present disclosure. Some features described in the context of a separate embodiment can also be implemented in a single embodiment in combination. On the contrary, the various features described in the context of a single embodiment can also be implemented in multiple embodiments individually or in any suitable sub-combination mode.

Although the subject matter has been described in language specific to structural features and/or methodological logical acts, it should be understood that the subject matter defined in the appended claims is not necessarily limited to the specific features or acts described above. On the contrary, the specific features and actions described above are only exemplary forms of implementing the claims.

I/We claim:

1. An image processing method, comprising:
obtaining an image to be processed, the image to be processed comprising at least two image elements;
obtaining structured data corresponding to the image elements by calling an image parsing model to process the image to be processed, wherein the structured data comprises position information and appearance information of the image elements, the position information represents position features of the image elements in the image to be processed, and the appearance information represents appearance features of the image elements in the image to be processed; and
generating an output image containing at least one of the image elements, in response to an editing instruction for the structured data.

2. The method according to claim 1, wherein the image parsing model comprises a large language model, and
obtaining the structured data corresponding to the image elements by calling the image parsing model to process the image to be processed comprises:
obtaining multi-level semantic information by performing feature extraction on the image to be processed, the multi-level semantic information representing semantic features of the image elements in at least two receptive field dimensions;
obtaining hierarchical data corresponding to the image to be processed by processing the multi-level semantic information through the large language model, the hierarchical data corresponding to the image elements one by one and being used to represent layer content of a layer where the image elements in the image to be processed are located; and
generating the structured data corresponding to the image elements by performing image reconstruction on the hierarchical data.

3. The method according to claim 2, wherein obtaining the multi-level semantic information by performing the feature extraction on the image to be processed comprises:
obtaining at least two types of visual encoders; and
obtaining the multi-level semantic information by performing the feature extraction on the image to be processed through the at least two types of visual encoders, and fusing a feature extraction result.

4. The method according to claim 2, wherein the image parsing model further comprises a vector quantization encoder and a vector quantization decoder, and
wherein obtaining the hierarchical data corresponding to the image to be processed by processing the multi-level semantic information through the large language model comprises:
obtaining an input encoding vector based on a quantization value by performing quantization encoding on the multi-level semantic information through the vector quantization encoder; and
obtaining the hierarchical data based on the quantization value by processing the input encoding vector through the large language model; and
wherein generating the structured data corresponding to the image elements by performing image reconstruction on the hierarchical data comprises:
generating the structured data corresponding to the image elements by performing quantization decoding on the hierarchical data through the vector quantization decoder.

5. The method according to claim 2, wherein the method further comprises:
receiving a user operation instruction, the user operation instruction being used to indicate a target image element in the image to be processed; and
wherein obtaining the hierarchical data corresponding to the image to be processed by processing the multi-level semantic information through the large language model comprises:
obtaining target hierarchical data corresponding to the target image element by processing the multi-level semantic information and the user operation instruction through the large language model.

6. The method according to claim 5, wherein obtaining the target hierarchical data corresponding to the target image element by processing the multi-level semantic information and the user operation instruction through the large language model comprises:
generating a model prompt word corresponding to the large language model based on the user operation instruction;
generating model input information based on the model prompt word and the multi-level semantic information; and
obtaining the target hierarchical data corresponding to the target image element by processing the model input information through the large language model.

7. The method according to claim 5, wherein the user operation instruction comprises a first operation instruction or a second operation instruction, wherein the first operation instruction comprises a coordinate value describing a position of the target image element; and the second operation instruction comprises text describing a position of the target image element.

8. The method according to claim 1, wherein the image elements comprise icon elements and text elements, the structured data comprises text structured data and image structured data, the image structured data is used to represent appearance features of the icon elements; the text structured data is used to represent text content and font attributes of the text elements, and
wherein generating the output image containing at least one of the image elements, in response to the editing instruction for the structured data comprises:
generating updated text structured data and/or updated icon elements, in response to the editing instruction for the text structured data and/or the image structured data; and
generating the output image based on the updated text structured data and/or a rendering result of the updated icon elements.

9. An electronic device, comprising: a processor and a memory;
the memory storing computer-executable instructions;
the processor executing the computer-executable instructions stored in the memory, causing the processor to:
obtain an image to be processed, the image to be processed comprising at least two image elements;
obtain structured data corresponding to the image elements by calling an image parsing model to process the image to be processed, wherein the structured data comprises position information and appearance information of the image elements, the position information represents position features of the image elements in the image to be processed, and the appearance information represents appearance features of the image elements in the image to be processed; and
generate an output image containing at least one of the image elements, in response to an editing instruction for the structured data.

10. The electronic device according to claim 9, wherein the image parsing model comprises a large language model, and the computer-executable instructions causing the processor to obtain the structured data corresponding to the image elements by calling the image parsing model to process the image to be processed comprise instructions to:
obtain the structured data corresponding to the image elements by calling the image parsing model to process the image to be processed comprises:
obtain multi-level semantic information by performing feature extraction on the image to be processed, the multi-level semantic information representing semantic features of the image elements in at least two receptive field dimensions;
obtain hierarchical data corresponding to the image to be processed by processing the multi-level semantic information through the large language model, the hierarchical data corresponding to the image elements one by one and being used to represent layer content of a layer where the image elements in the image to be processed are located; and
generate the structured data corresponding to the image elements by performing image reconstruction on the hierarchical data.

11. The electronic device according to claim 10, wherein the computer-executable instructions causing the processor to obtain the multi-level semantic information by performing the feature extraction on the image to be processed comprise instructions to:
obtain at least two types of visual encoders; and
obtain the multi-level semantic information by performing the feature extraction on the image to be processed through the at least two types of visual encoders, and fusing a feature extraction result.

12. The electronic device according to claim 10, wherein the image parsing model further comprises a vector quantization encoder and a vector quantization decoder, and the computer-executable instructions causing the processor to obtain the hierarchical data corresponding to the image to be processed by processing the multi-level semantic information through the large language model comprise instructions to:
obtain an input encoding vector based on a quantization value by performing quantization encoding on the multi-level semantic information through the vector quantization encoder; and
obtain the hierarchical data based on the quantization value by processing the input encoding vector through the large language model; and
wherein generating the structured data corresponding to the image elements by performing image reconstruction on the hierarchical data comprises:
generating the structured data corresponding to the image elements by performing quantization decoding on the hierarchical data through the vector quantization decoder.

13. The electronic device according to claim 10, wherein the computer-executable instructions further comprise instructions to:
receive a user operation instruction, the user operation instruction being used to indicate a target image element in the image to be processed; and
wherein obtaining the hierarchical data corresponding to the image to be processed by processing the multi-level semantic information through the large language model comprises:
obtaining target hierarchical data corresponding to the target image element by processing the multi-level semantic information and the user operation instruction through the large language model.

14. The electronic device according to claim 13, wherein the computer-executable instructions causing the processor to obtain the target hierarchical data corresponding to the target image element by processing the multi-level semantic information and the user operation instruction through the large language model comprise instructions to:
generate a model prompt word corresponding to the large language model based on the user operation instruction;
generate model input information based on the model prompt word and the multi-level semantic information; and
obtain the target hierarchical data corresponding to the target image element by processing the model input information through the large language model.

15. The electronic device according to claim 13, wherein the user operation instruction comprises a first operation instruction or a second operation instruction, wherein the first operation instruction comprises a coordinate value describing a position of the target image element; and the second operation instruction comprises text describing a position of the target image element.

16. The electronic device according to claim 9, wherein the image elements comprise icon elements and text elements, the structured data comprises text structured data and image structured data, the image structured data is used to represent appearance features of the icon elements; the text structured data is used to represent text content and font attributes of the text elements, and
wherein the computer-executable instructions causing the processor to generate the output image containing at least one of the image elements, in response to the editing instruction for the structured data comprise instructions to:
generate updated text structured data and/or updated icon element, in response to the editing instruction for the text structured data and/or the image structured data; and
generate the output image based on the updated text structured data and/or a rendering result of the updated icon element.

17. A non-transitory computer-readable storage medium, storing computer-executable instructions which, when executed by a processor, causing the processor to:
obtain an image to be processed, the image to be processed comprising at least two image elements;
obtain structured data corresponding to the image elements by calling an image parsing model to process the image to be processed, wherein the structured data comprises position information and appearance information of the image elements, the position information represents position features of the image elements in the image to be processed, and the appearance information represents appearance features of the image elements in the image to be processed; and
generate an output image containing at least one of the image elements, in response to an editing instruction for the structured data.

18. The storage medium according to claim 17, wherein the image parsing model comprises a large language model, and the computer-executable instructions causing the processor to obtain the structured data corresponding to the image elements by calling the image parsing model to process the image to be processed comprise instructions to:
obtain the structured data corresponding to the image elements by calling the image parsing model to process the image to be processed comprises:
obtain multi-level semantic information by performing feature extraction on the image to be processed, the multi-level semantic information representing semantic features of the image elements in at least two receptive field dimensions;
obtain hierarchical data corresponding to the image to be processed by processing the multi-level semantic information through the large language model, the hierarchical data corresponding to the image elements one by one and being used to represent layer content of a layer where the image elements in the image to be processed are located; and
generate the structured data corresponding to the image elements by performing image reconstruction on the hierarchical data.

19. The storage medium according to claim 18, wherein the computer-executable instructions causing the processor to obtain the multi-level semantic information by performing the feature extraction on the image to be processed comprise instructions to:
obtain at least two types of visual encoders; and
obtain the multi-level semantic information by performing the feature extraction on the image to be processed through the at least two types of visual encoders, and fusing a feature extraction result.

20. The storage medium according to claim 18, wherein the image parsing model further comprises a vector quantization encoder and a vector quantization decoder, and the computer-executable instructions causing the processor to obtain the hierarchical data corresponding to the image to be processed by processing the multi-level semantic information through the large language model comprise instructions to:
obtain an input encoding vector based on a quantization value by performing quantization encoding on the multi-level semantic information through the vector quantization encoder; and
obtain the hierarchical data based on the quantization value by processing the input encoding vector through the large language model; and
wherein generating the structured data corresponding to the image elements by performing image reconstruction on the hierarchical data comprises:
generating the structured data corresponding to the image elements by performing quantization decoding on the hierarchical data through the vector quantization decoder.
